(19) United States
(12) Patent Application Publication
(10) Pub. No.: US 2006/0215709 A1
(43) Pub. Date: Sep. 28, 2006

(54) Code conversion circuit

(75) Inventor: Naoki Kuwata, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/150,306

(22) Filed: Jun. 13, 2005

(30) Foreign Application Priority Data
Mar. 25, 2005 (JP) 2005-088223

(51) Int. Cl. H04J 3/04

(52) U.S. Cl. 370/535

(57) ABSTRACT

A code conversion circuit is disclosed that converts a NRZ data signal into another NRZ data signal. The code conversion circuit includes a demultiplexer to demultiplex a NRZ data signal into plural parallel data signals, a conversion circuit to receive the demultiplexed parallel data signals, and a multiplexer to multiplex plural data signals output from the conversion circuit. The conversion circuit includes a first exclusive OR circuit to calculate logical exclusive OR of a first data signal of the parallel data signals and a second data signal of parallel data signals that is delayed by one bit by a delay circuit, an AND circuit to calculate logical AND of an output signal representing the logical exclusive OR calculated by the first exclusive OR circuit and a clock signal corresponding to a transmission speed of the parallel data signals, a T flip-flop to receive an output signal representing the logical AND calculated by the AND circuit, and a second exclusive OR circuit to calculate logical exclusive OR of a NRZ data signal output from the T flip-flop and the second data signal.

### BACKGROUND OF THE INVENTION

1. Field of the Invention

The present invention relates to a code conversion circuit applicable to a DPSK (Differential Phase Shift Keying) modulation scheme.

2. Description of the Related Art

A wide variety of optical communication systems have been developed along with growing demands for data communication. Common optical communication systems send and receive data in the form of optical signals corresponding to, for example, “1” and “0” according to a light intensity modulation scheme. When multiplexing of multiple optical signals with different wavelengths is implemented, optical communication systems can transmit data at a speed faster than using single-wavelength optical signals in proportion to the number of wavelengths. Also, various optical communication systems that modulate the phase of optical signals of transmitted data have been proposed.

FIG. 7 shows an example of an optical communication system utilizing a DPSK (Differential Phase Shift Keying) modulation scheme for modulating the phase of optical signals. This system comprises a transmitter 51 and a receiver 52 connected via an optical transmission line. The transmitter 51 includes a laser diode (LD) 53, a phase modulator 54, a code conversion circuit 55, and an intensity modulator 56. The receiver 52 includes a delay interferometer 57, a direct detection circuit 58, and a clock optical receiver 59. In this system, for example, data in the form of a 40 Gb/s NRZ signal are input to the code conversion circuit 55. The data are converted into signals of in-phase components and quadrature components while going through differential encoding. Then, the differentially encoded output signals are input to the phase modulator 54.

The phase modulator 54 modulates the phase of optical signals to 0 or n phase according to the differentially encoded signals so as to output DPSK modulated optical signals. The intensity modulator 56 modulates the intensity of the DPSK modulated optical signals according to separately input clock signals so as to output the DPSK modulated optical signals that are RZ pulsed according to the clock signal period to the optical transmission line.

The receiver 52 receives the RZ-DPSK modulated optical signals via the optical transmission line and inputs them to the delay interferometer 57. If the clock optical receiver 59 is provided, the optical signals, of which intensity is modulated at the transmitter side according to the clock signals, are converted into electric signals to obtain clock signal components. The direct detection circuit 58, including a photoelectric transducer, outputs data synchronized with the clock signals using the clock signals.

FIGS. 8A and 8B illustrate main parts of a related-art code conversion circuit. As shown in FIG. 8A, the code conversion circuit has an AND circuit 61 and a T flip-flop (T-FF) 62. A NRZ data signal (1) and a clock signal (2) are input to the AND circuit 61. The AND circuit 61 calculates logical AND of the NRZ data signal (1) and the clock signal (2), and inputs an AND signal (3) to the T-FF 62. The T-FF 62 converts the AND signal (3) into a NRZ signal (4). These signals (1) through (4) are illustrated in FIG. 8B. The pulse width of the 40 Gb/s NRZ data signal (1) is 25 ps. The pulse width of the clock signal (2) is 12.5 ps. Therefore, the pulse width of the AND output signal (3) becomes 12.5 ps. The output signal (4) from the T-FF 62 is a NRZ signal based on a logical expression of z(n)=z(n−1)+d(n), wherein “+” indicates logical exclusive OR (EXOR). Therefore, components including the AND circuit 61 require 12.5 Ps pulse width, or an operating speed of 80 Gb/s, twice as fast as 40 Gb/s.

A method for reducing the operating speed of components relative to a data transmission speed is disclosed in, for example, Japanese Patent Laid-Open Publication No. 11-298539 (corresponding to U.S. Pat. No. 6,429,838), where data are reconstructed in two parallel streams so as to be processed according to clock signals having a half frequency. There is another method disclosed in, for example, Japanese Patent Laid-Open Publication No. 2000-165246 (corresponding to U.S. Pat. No. 6,595,707) that reconstructs a high-speed input signal into N parallel systems, inputs them to corresponding code converters, synthesizes signals output from the code converters by a bit synthesizer, and outputs the synthesized signal as codes for optical dual binary transmission.

In the related-art code conversion circuit where the 40 Gb/s data signals are processed according to the 40 GHz clock signals, although the pulse width of the NRZ data signals of 40 Gb/s is 25 ps, the pulse width of the AND output signal (3) is 12.5 ps as described above. Therefore, a circuit element requires an operating speed of 80 Gb/s, twice as fast as 40 Gb/s. Circuit elements having such high operating speed are very expensive. Moreover, it is difficult to realize a configuration that can stably operate such circuit elements.

### SUMMARY OF THE INVENTION

A general object of the present invention is to provide a code conversion circuit to solve at least one problem described above. A specific object of the present invention is to provide a code conversion circuit that converts a NRZ signal into another NRZ signal where code conversion processing can be performed at an operating speed corresponding to or lower than a transmission speed.

According to an aspect of the present invention, there is provided a code conversion circuit that converts a NRZ data signal into another NRZ data signal, comprising a demultiplexer to demultiplex a NRZ data signal into plural parallel data signals, a conversion circuit to receive the parallel data signals demultiplexed by the demultiplexer, and a multiplexer to multiplex plural data signals output from the conversion circuit, wherein the conversion circuit is configured to convert a signal representing logical exclusive OR of a first data signal of the parallel data signals and a second data signal of the parallel data signals that is delayed by one bit into a signal having a pulse width according to a clock signal corresponding to a transmission speed of the parallel data signals, convert the signal having said pulse width into a NRZ data signal by T flip-flopping, and convert a data signal representing logical exclusive OR of said NRZ data signal and the second data signal into another NRZ data signal to be output.

The conversion circuit preferably includes a first exclusive OR circuit to calculate logical exclusive OR of the first data signal of the parallel data signals demultiplexed by the demultiplexer and the one-bit delayed second data signal, an AND circuit to calculate logical AND of the output signal representing the logical exclusive OR calculated by the first exclusive OR circuit and the clock signal corresponding to the transmission speed of the parallel data signals, a T flip-flop to receive an output signal representing the logical AND calculated by the AND circuit, and a second exclusive OR circuit to calculate logical exclusive OR of the NRZ data signal output from the T flip-flop and the second data signal.

According to another aspect of the present invention, there is provided a code conversion circuit that converts a NRZ data signal into another NRZ data signal, comprising a demultiplexer to demultiplex a NRZ data signal into plural parallel data signals, a conversion circuit to receive the parallel data signals demultiplexed by the demultiplexer, and a multiplexer to multiplex plural data signals output from the conversion circuit, wherein the conversion circuit includes a first exclusive OR circuit to calculate logical exclusive OR of a first data signal of the parallel data signals and a second data signal of the parallel data signals to produce an output signal, an AND circuit to calculate logical AND of the output signal of the first exclusive OR circuit and a clock signal corresponding to a transmission speed of the parallel data signals to produce an output signal, a T flip-flop to receive the output signal of the AND circuit, a delay circuit to delay an output signal output from the T flip-flop by one bit, and a second exclusive OR circuit to calculate logical exclusive OR of the one-bit delayed output signal delayed by the delay circuit and the first data signal of the parallel data signals.

In an operation of converting a NRZ data signal into another NRZ data signal, the NRZ data signal is demultiplexed into parallel data signals, and a clock signal corresponding to a transmission speed of the parallel data signals is used. The code conversion circuit can be therefore formed with circuits that operate at a speed corresponding to or lower than the bit rate of the NRZ data signal. Accordingly, cost reduction and stable operation of the code conversion circuit can be achieved.

### BRIEF DESCRIPTION OF THE DRAWINGS

FIG. 1 illustrates a first embodiment of the present invention;

FIG. 2 illustrates operations of the first embodiment of the present invention;

FIG. 3 illustrates a second embodiment of the present invention;

FIG. 4 illustrates operations of the second embodiment of the present invention;

FIG. 5 illustrates a third embodiment of the present invention;

FIG. 6 illustrates operations of the third embodiment of the present invention;

FIG. 7 schematically illustrates a DPSK modulation optical signal transmission system; and

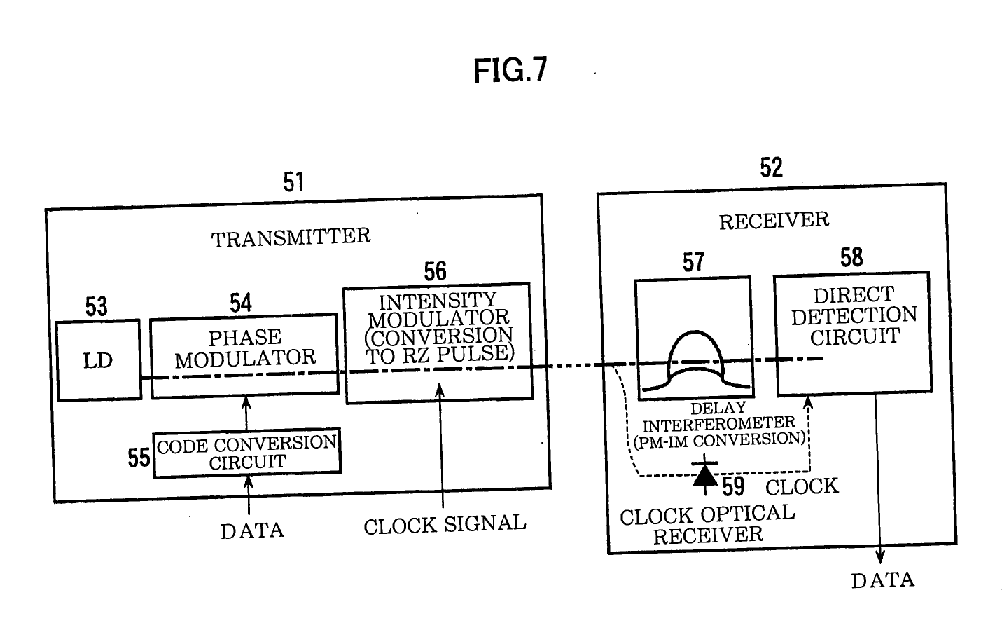

FIGS. 8A and 8B illustrate main parts of a related-art code conversion circuit.

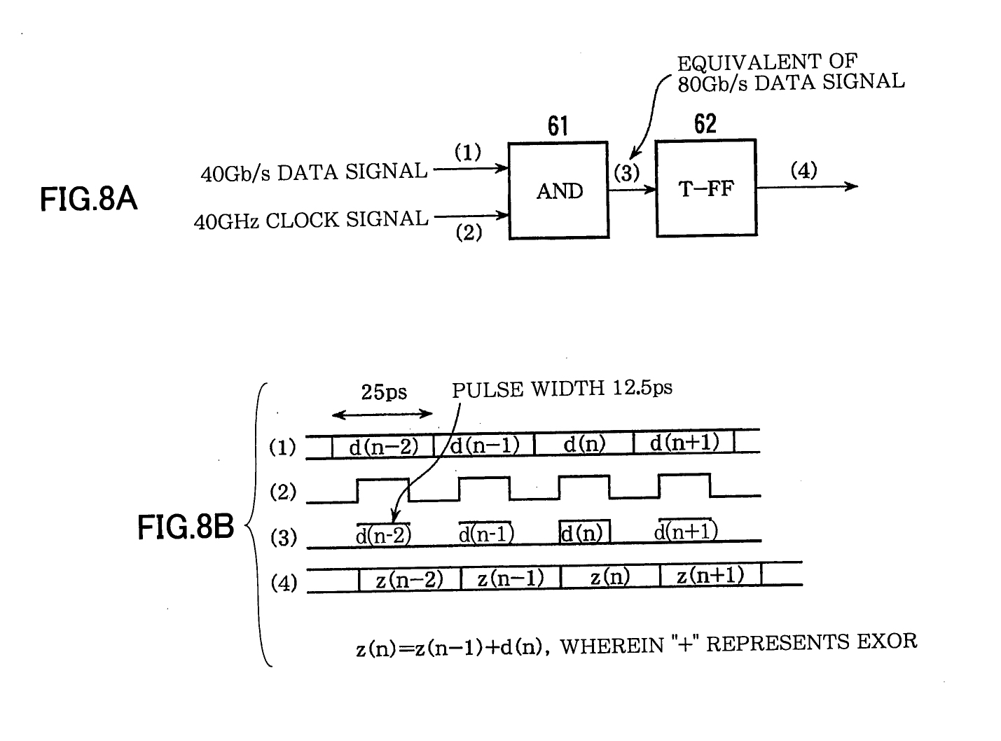

### DETAILED DESCRIPTION OF THE PREFERRED EMBODIMENT

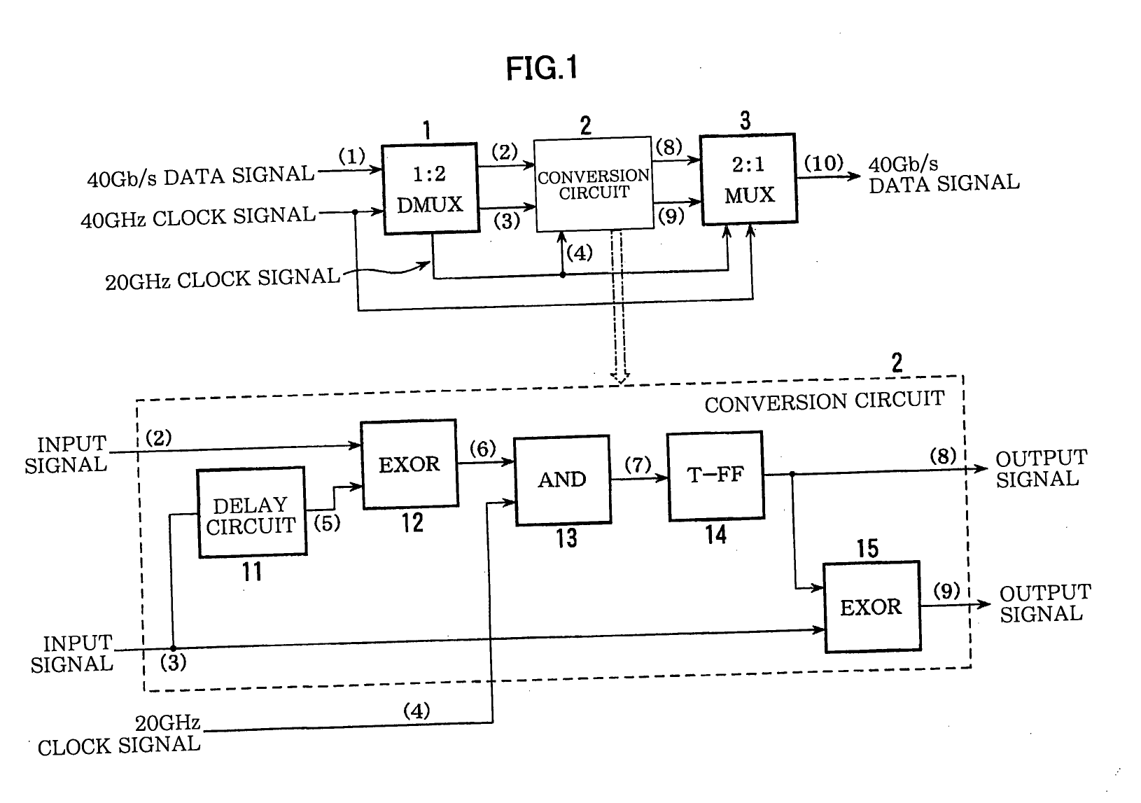

Referring to FIG. 1, a code conversion circuit of the present invention comprises a demultiplexer 1 that demultiplexes a NRZ data signal, a conversion circuit 2 that inputs plural parallel data signals demultiplexed by the demultiplexer 1, and a multiplexer 3 that multiplexes the plural parallel data signals output from the conversion circuit 2. The conversion circuit 2 comprises a delay circuit 11 that delays one of the parallel data signals demultiplexed by the demultiplexer 1 by one bit, a first exclusive OR (EXOR) circuit 12 that calculates logical exclusive OR of the delayed signal and one of the demultiplexed but not delayed parallel data signals, an AND circuit 13 that calculates logical AND of the output signal from the first EXOR circuit 12 and a clock signal corresponding to a transmission speed of the parallel data signals, a T flip-flop (T-FF) 14 that receives the output signal from the AND circuit 13, and a second EXOR circuit 15 that calculates logical exclusive OR of a NRZ data signal output from the T-FF 14 and the demultiplexed but not delayed data signal.

### First Embodiment

FIG. 1 illustrates a first embodiment of the present invention, showing a demultiplexer (1:2 DMUX) denoted by the reference number 1, a conversion circuit denoted by 2, and a multiplexer (2:1 MUX) denoted by 3. As shown in a dotted box indicated by a dotted arrow in detail, the conversion circuit 2 comprises a delay circuit 11, a first EXOR circuit 12, an AND circuit 13, a T-FF 14, and a second EXOR circuit 15.

A 40 Gb/s NRZ data signal (1) and a 40 GHz clock signal are input to the demultiplexer 1. The demultiplexer 1 demultiplexes the data signal (1) into two streams at 1:2 so as to input 20 Gb/s data signals (2) and (3) to the conversion circuit 2. The demultiplexer 1 also converts the 40 GHz clock signal into a 20 GHz clock signal (4) corresponding to a transmission speed of parallel data signals and inputs the 20 GHz clock signal to the conversion circuit 2 and the multiplexer 3.

The conversion circuit 2 inputs the data signal (2) directly to the first EXOR circuit 12 and the data signal (3) to the first EXOR circuit 12 through the delay circuit 11 as a delayed signal (5) delayed by one bit. An output signal (6) from the first EXOR circuit 12 and the clock signal (4) are input to the AND circuit 13. An output signal (7) from the AND circuit 13 is input to the T-FF 14 and is output as an output signal (8). The output signal (8) and the input signal (3) are input to the second EXOR circuit 15 and are output as an output signal (9). The output signals (8) and (9) are multiplexed by the multiplexer 3 to be a 40 Gb/s differentially encoded NRZ data signal. That is, a NRZ data signal is converted into a NRZ differentially encoded data signal, or another NRZ data signal.

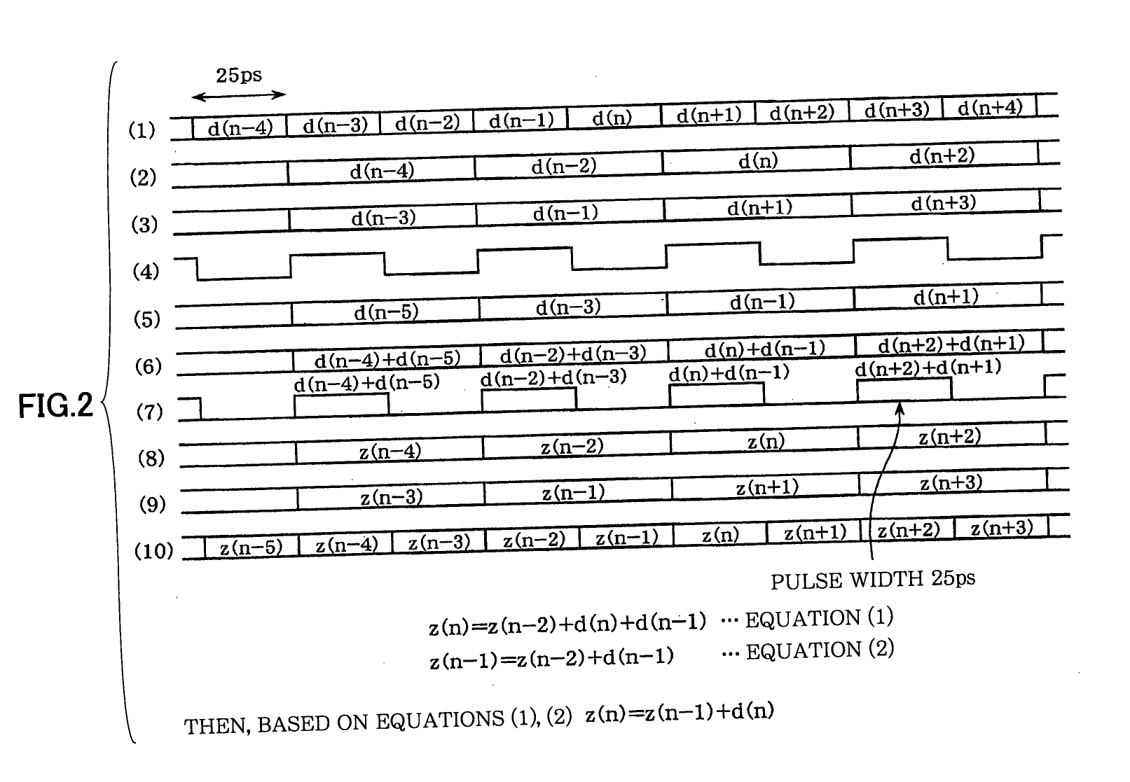

FIG. 2 illustrates operations of the conversion circuit, showing an example of signals (1) through (10) of FIG. 1. The pulse width of the 40 Gb/s data signal (1) is 25 ps. The pulse width of the data signals (2) and (3), which are obtained by demultiplexing the data signal (1) into two streams by the 1:2 demultiplexer 1, is 50 ps. For example, d(n) and d (n+1) of the 40 Gb/s data signal (1) are transformed into d(n) of the 20 Gb/s data signal (2) and d(n+1) of the data signal (3).

The d(n) of the data signal (2) and d(n−1) of the data signal (5), which is the data signal (3) delayed by one bit by the delay circuit 11, are input to the first EXOR circuit 12. Then, the first EXOR circuit 12 outputs d(n)+d(n−1), wherein “+” indicates logical exclusive OR, as an output signal (6). Then, the AND circuit 13 calculates logical AND of the output signal (6) and the clock signal (4), and outputs an output signal (7) having a pulse width of 25 ps. The output signal (7) is input to the T-FF 14 so as to be inverted according to, for example, logical “1”, and are output as a NRZ output signal (8). The output signal (8) from the T-FF 14 and the data signal (3) are input to the second EXOR circuit 15, and are output as an output signal (9). The output signal (8) corresponds to z(n) in Equation (1) and the output signal (9) corresponds to z(n−1) in Equation (2). Accordingly, a data signal (10) multiplexed by the 2:1 multiplexer 3 according to the 40 GHz clock signal is the sum of Equations (1) and (2), i.e., z(n)=z(n−1)+d(n). For instance, when the NRZ data signal (1) is “**010011101**” and the initial value of the output signal from the T-FF 14 is “0”, the converted NRZ data signal (10) become “**11101001**”.

As a result, a circuit element in the conversion circuit 2 dose not need to have an operating speed higher than 40 Gb/s for processing of 40 Gb/s data signals. This ensures stable operations of the code conversion circuit that converts a NRZ data signal into another NRZ data signal such as a differentially encoded data signal and realizes cost reduction. Even if the operating speed of the circuit element is further improved by technological developments and therefore transmission speed of the data signals is further increased, stable operations and cost reductions can be easily realized.

### Second Embodiment

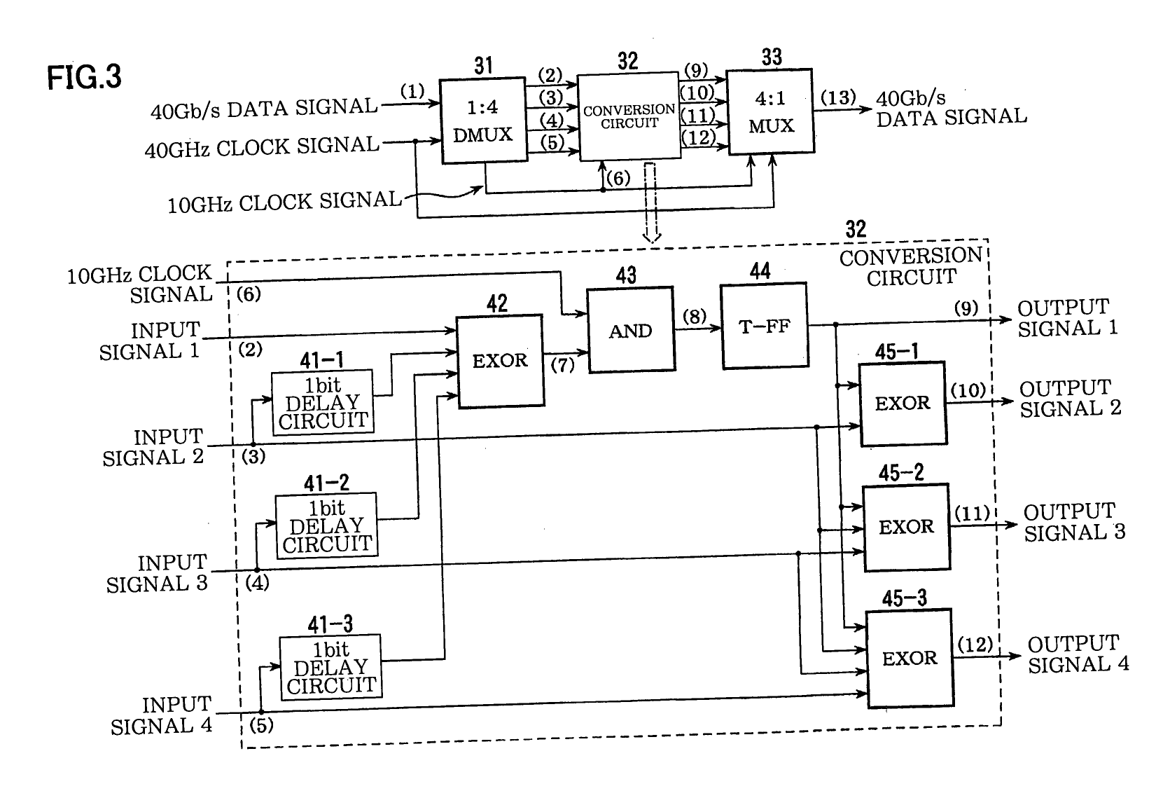

FIG. 3 illustrates a second embodiment of the present invention, showing a demultiplexer (1:4 DMUX) denoted by the reference number 31, a conversion circuit denoted by 32, and a multiplexer (4:1 MUX) denoted by 33. As shown in a dotted box indicated by a dotted arrow in detail, the conversion circuit 32 comprises delay circuits 41-1 through 41-3, a first EXOR circuit 42, an AND circuit 43, a T-FF 44, and second EXOR circuits 45-1 through 45-3.

A 40 Gb/s NRZ data signal (1) and a 40 GHz clock signal are input to the demultiplexer 31. The demultiplexer 31 demultiplexes the data signal (1) into four streams at 1:4 so as to input 10 Gb/s data signals (2) through (5) to the conversion circuit 32. The demultiplexer 31 also converts the 40 GHz clock signal into a 10 GHz clock signal (4) and inputs the 10 GHz clock signal to the conversion circuit 32 and the multiplexer 33.

The conversion circuit 32 inputs the data signals (2) through (5) as input signals 1 through 4, inputs a 10 GHz clock signal (6) to the AND circuit 43, inputs one data signal (2) (input signal 1) of the four streams of the 10 Gb/s data signals to the EXOR circuit 42, and inputs the other three data signals (3) through (5) (input signals 2 through 4) to the EXOR circuit 42 through the one-bit delay circuits 41-1 through 41-3, respectively. An output signal (7) from the EXOR circuit 42 is input to the AND circuit 43 to be output as an output signal (8) synchronized with the clock signal (6) to the T-FF 44. An output signal (9) (output signal 1) from the T-FF 44 is input to each of the EXOR circuits 45-1 through 45-3. The EXOR circuit 45-1 calculates logical exclusive OR of the data signal (3) of the input signal 2 and the data signal (9) of the output signal 1 to output it as an output signal 2. The EXOR circuit 45-2 calculates logical exclusive OR of the data signals (3) and (4) of the input signals 2 and 3 and the data signal (9) of the output signal 1 to output it as an output signal 3. The EXOR circuit 45-3 calculates logical exclusive OR of the data signals (3) through (5) of the input signals 2 through 4 and the data signal (9) of the output signal 1 to output it as an output signal 4.

These output signals 1 through 4 (the data signals (9) through (12)) are multiplexed by the 4:1 multiplexer 33 according to the 10 GHz clock signal (6) and the 40 GHz clock signal, so that the output signals 1 through 4 from the conversion circuit 32 are quadruplicated according to the 40 GHz clock signal and the 10 GHz clock signal to be output as a 40 Gb/s NRZ data signal (13).

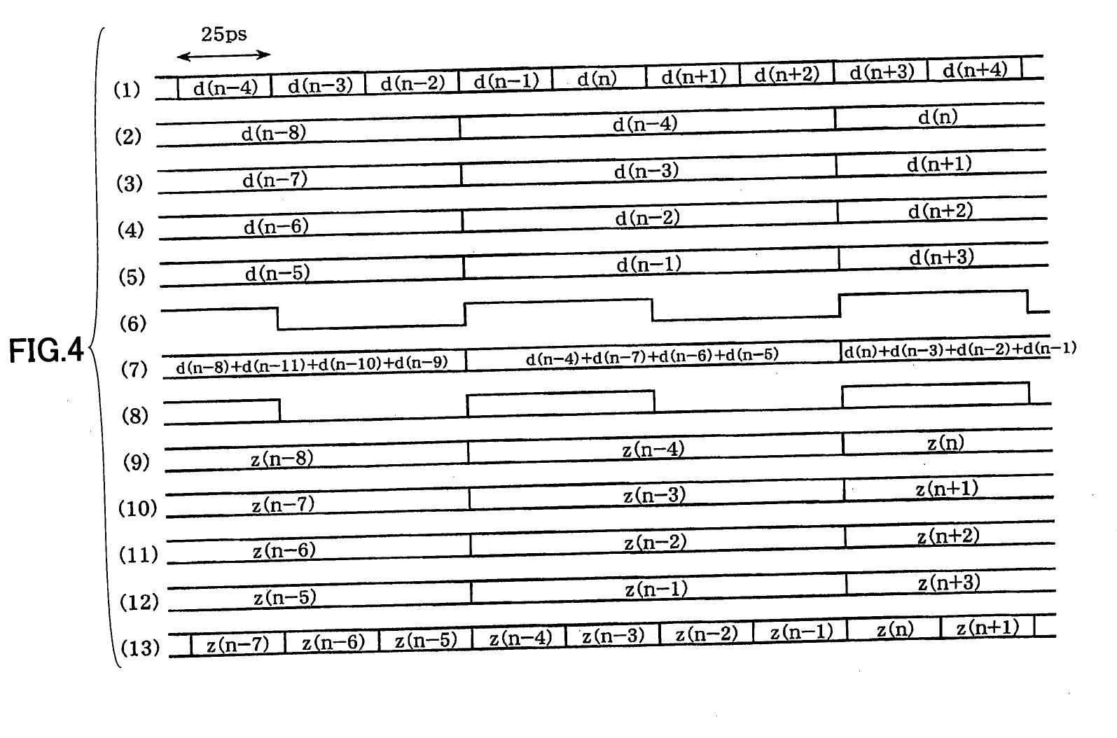

FIG. 4 illustrates operations of the second embodiment of the present invention, showing an example of signals (1) through (13) of FIG. 3. As mentioned above, the 40 Gb/s input data signal (1) having a pulse width of 25 ps is demultiplexed into the data signals (2) through (5) by the 1:4 demultiplexer 31 to become, for example, four parallel data signals d(n) through d(n−3) each having a pulse width of 100 ps. Then, the 10 GHz clock signal (6) is input to the conversion circuit 32.

The EXOR circuit 42 of the conversion circuit 32 outputs an calculation result of, for example, d(n)+d(n−3)+d(n−2)+d(n−1) (wherein “+” indicates logical exclusive OR) as the output signal (7) to the AND circuit 43. The AND circuit 43 outputs the AND output signal (8) to the T-FF 44. The T-FF 44 outputs the NRZ output signal (9) to the 4:1 multiplexer 33 and to the EXOR circuits 45-1 through 45-3. The output signal 1 (9) from the T-FF 44 and output signals 2 (10) through 4 (12) from the EXOR circuits 45-1 through 45-3 are input to the 4:1 multiplexer 33. The output signals 1 (9) through 4 (12) are quadruplicated to be synchronized with the 10 GHz clock signal (6), and output as the 40 Gb/s NRZ data signal (13).

According to the second embodiment, a NRZ 40 Gb/s NRZ data signal can be converted into another NRZ data signal (e.g. a NRZ data signal for differentially encoded modulation) at a data signal speed of 10 Gb/s. Accordingly, by demultiplexing data signals having a higher data transmission speed into the greater number of streams, the code conversion circuit can be formed with controllable circuit elements.

### Third Embodiment

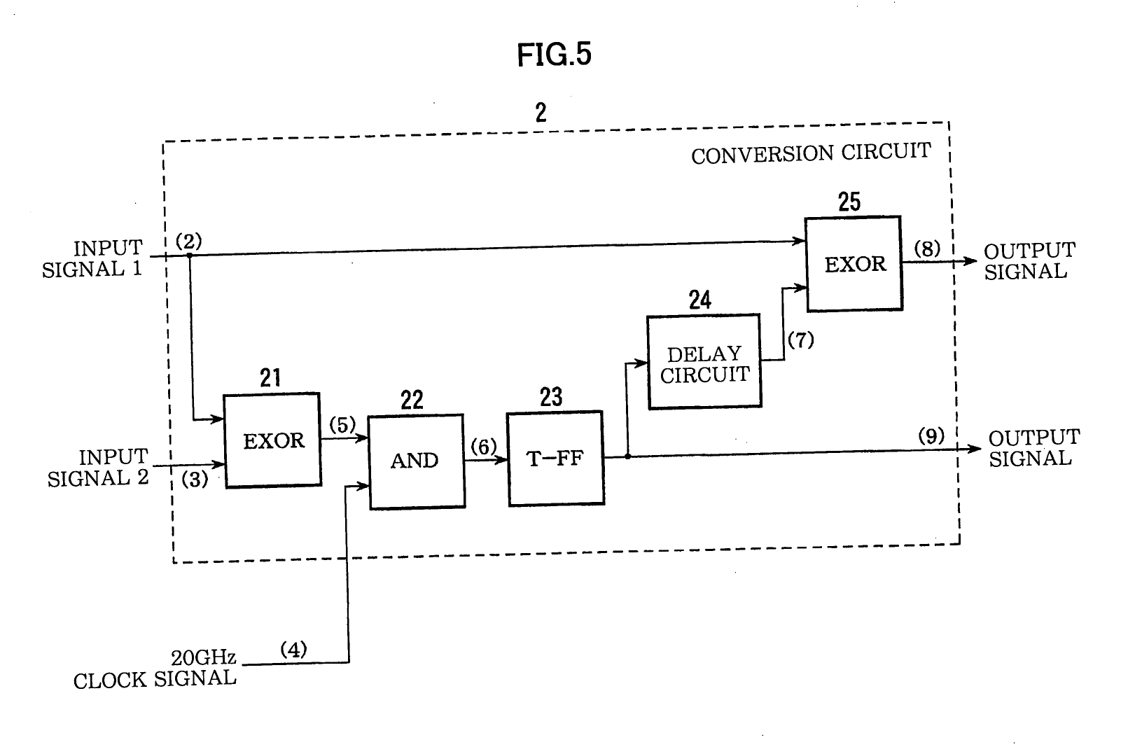

FIG. 5 illustrates a conversion circuit 2 according a third embodiment of the present invention that corresponds to the conversion circuit 2 of FIG. 1. FIG. 5 shows a first EXOR circuit denoted by the reference number 21, an AND circuit denoted by 22, a T-FF denoted by 23, a one-bit delay circuit denoted by 24, a second EXOR circuit denoted by 25, and signals output from corresponding components denoted by (2) through (9).

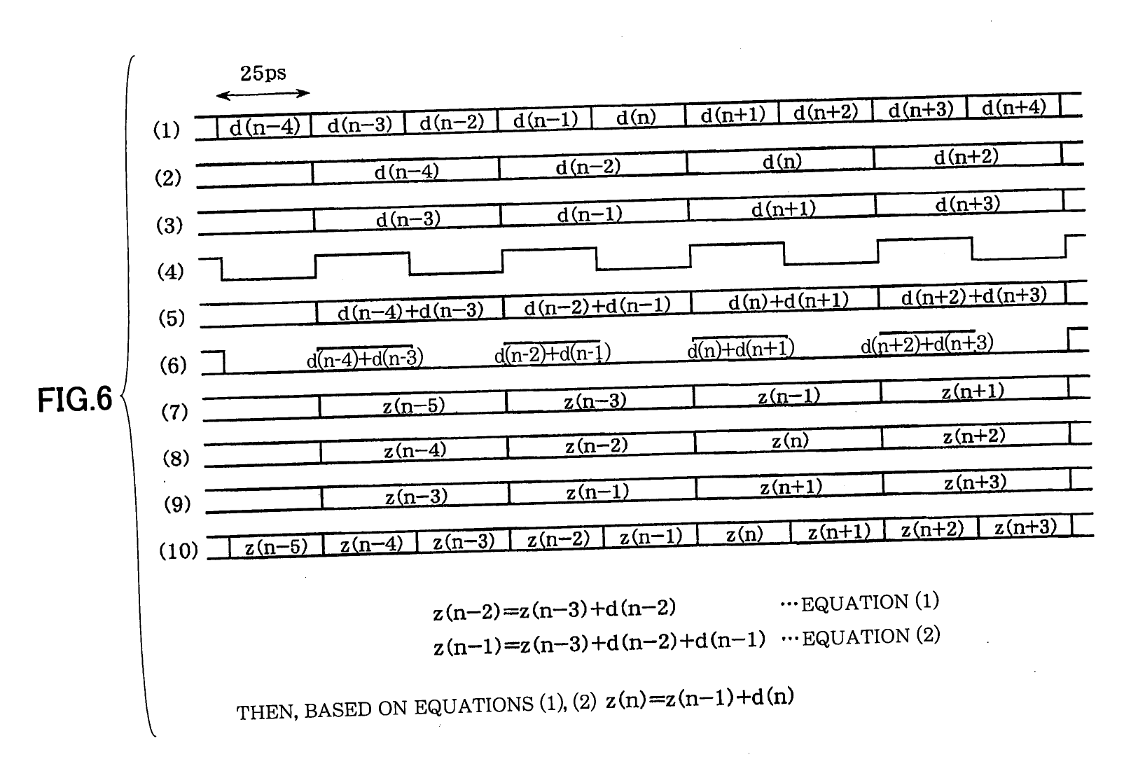

FIG. 6 illustrates operations of the third embodiment, showing the signals (2) through (9) of FIG. 5, the 40 Gb/s input signal (1) (FIG. 1) yet to be demultiplexed by the demultiplexer, and the output signal (10) (FIG. 1) multiplexed by the multiplexer. The 40 Gb/s NRZ input signal (1) having a pulse width of 25 ps is demultiplexed into a larger number of demultiplexed signals by the demultiplexer. (Although 1:2 demultiplexing is performed in the third embodiment as in the first embodiment, demultiplexing into plural data signals as in the second embodiment may be performed.) One input signal (2) (data signal) of the plural signals and another input signal (3) are input to the first EXOR circuit 21. The first EXOR circuit 21 outputs the EXOR output signal (5) to the AND circuit 22. The AND circuit 22 calculates logical AND of the EXOR output signal (5) and the 20 GHz clock signal (4) and outputs the logical AND as the output signal (6) to the T-FF 23. The output signal (6) from the AND circuit 22 has a pulse width of 25 ps.

The T-FF 23 outputs the output signal (9), and the one-bit delay circuit 24 delays the output signal (9) to output it as the signal (7). The signals (7) and (2) are input to the second EXOR circuit 25. The output signal (8) from the second EXOR circuit 25 and the output signal (9) from the T-FF 23 are input to the multiplexer (FIG. 1), and are multiplexed to be output as the NRZ output signal (10) (data signal). The output signal (10) is a NRZ data signal according to an Equation: z(n)=z(n−1)+d(n), which is based on Equation (1): z(n−2)=z(n−3)+d(n−2) and Equation (2): z(n−1)=z(n−3)+d(n−2)+d(n−1). That is, a NRZ data signal d(n) can be converted into another NRZ data signal z(n).

The present application is based on Japanese Priority Application No. 2005-088223 filed on Mar. 25, 2005, with the Japanese Patent Office, the entire contents of which are hereby incorporated by reference.

What is claimed is:

1. A code conversion circuit that converts a NRZ data signal into another NRZ data signal, comprising:
a demultiplexer to demultiplex a NRZ data signal into a plurality of parallel data signals;
a conversion circuit to receive the parallel data signals demultiplexed by the demultiplexer; and
a multiplexer to multiplex a plurality of data signals output from the conversion circuit;
wherein the conversion circuit is configured to convert an output signal representing logical exclusive OR of a first data signal of the parallel data signals and a second data signal of the parallel data signals that is delayed by one bit, into a signal having a pulse width according to a clock signal corresponding to a transmission speed of the parallel data signals, convert the signal having said pulse width into a NRZ data signal by T flip-flopping, and convert a data signal representing logical exclusive OR of said NRZ data signal and the second data signal into another NRZ data signal to be output.

2. The code conversion circuit as claimed in claim 1, wherein the conversion circuit includes:
a first exclusive OR circuit to calculate logical exclusive OR of the first data signal of the parallel data signals demultiplexed by the demultiplexer and the one-bit delayed second data signal;
an AND circuit to calculate logical AND of the output signal representing the logical exclusive OR calculated by the first exclusive OR circuit and the clock signal corresponding to the transmission speed of the parallel data signals;
a T flip-flop to receive an output signal representing the logical AND calculated by the AND circuit; and
a second exclusive OR circuit to calculate logical exclusive OR of the NRZ data signal output from the T flip-flop and the second data signal.

3. A code conversion circuit that converts a NRZ data signal into another NRZ data signal, comprising:
a demultiplexer to demultiplex a NRZ data signal into a plurality of parallel data signals;
a conversion circuit to receive the parallel data signals demultiplexed by the demultiplexer; and
a multiplexer to multiplex a plurality of data signals output from the conversion circuit;
wherein the conversion circuit includes
a first exclusive OR circuit to calculate logical exclusive OR of a first data signal of the parallel data signals and a second data signal of the parallel data signals to produce an output signal;
an AND circuit to calculate logical AND of the output signal of the first exclusive OR circuit and a clock signal corresponding to a transmission speed of the parallel data signals to produce an output signal;
a T flip-flop to receive the output signal of the AND circuit;
a delay circuit to delay an output signal output from the T flip-flop by one bit; and
a second exclusive OR circuit to calculate logical exclusive OR of the one-bit delayed output signal delayed by the delay circuit and the first data signal of the parallel data signals.
